(19) United States
(12) Patent Application Publication
(10) Pub. No.: US 2006/0129481 A1
(43) Pub. Date: Jun. 15, 2006

(54) System and method for self-monitoring credit information

(75) Inventors: Suneet Bhatt, Jersey City, NJ (US); Juliana Magill, Montclair, NJ (US); Carolyn Menz, Bethlehem, PA (US); Houston Itzen, Chatham, NJ (US); Raina Mehta, New York, NY (US); Kathy Reynard, Easton, PA (US); Alex Vengerovsky, Warren, NJ (US)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: DUN & BRADSTREET, INC.

(21) Appl. No.: 11/152,593

(22) Filed: Jun. 14, 2005

Related U.S. Application Data
(60) Provisional application No. 60/579,349, filed on Jun. 14, 2004.

(51) Int. Cl. G06Q 40/00

(52) U.S. Cl. 705/39

(57) ABSTRACT

There is provided a method for monitoring business information. The method includes the computer-implemented steps of automatically and periodically accessing business information on a business entity from one or more databases, updating a business information database with the business information, updating at least one business information report on the business entity from the business information database, and automatically alerting a user of a change in the business information report. There is also provided a computer system and a computer readable medium for monitoring business information.

### CROSS-REFERENCE TO RELATED APPLICATIONS

The present application is claiming priority of U.S. Provisional Patent Application Ser. No. 60/579,349, filed on Jun. 14, 2004, the content of which is herein incorporated by reference.

### BACKGROUND OF THE INVENTION

1. Field of the Invention

The present invention relates to business information reports, specifically to the monitoring of business information reports.

2. Description of the Related Art

Conventional self-monitoring systems only provide data from a comprehensive report. There is a need for a system and method for monitoring business information that utilizes a number of reports to provide a real-time monitoring of a company's credit.

### SUMMARY OF THE INVENTION

A self-monitor system and method, hereinafter “Selfmonitor” or “SelfMonitor”, allows customers to monitor their own company's credit information. Selfmonitor consolidates the information available on a company through various credit reports offered through a credit agency or database. It provides customers with tools to monitor changes to their business credit file and compare their business to other companies of the same size, age and industry., It also highlights the company's strengths and weaknesses, which provides the customer with unique insight into how his/her company is seen by business partners, suppliers, customers and prospects.

A method, a computer system, and a computer readable medium for monitoring business information is provided. An embodiment of the method of the present invention includes the computer-implemented steps of automatically and periodically accessing business information on a business entity from one or more databases, updating a business information database with the business information, updating at least one business information report on the business entity from the business information database, and automatically alerting a user of a change in the business information report.

In another embodiment of the present invention, the method further includes, upon request from the user, delivering the at least one business information report to the user.

In another embodiment of the method of the present invention, the database is at least one credit report.

In another embodiment of the method of the present invention, the business information report includes information selected from the group consisting of: credit information, payment history, key business ratios that measure financial strength, profitability, debts, assets, corporate relationships, and any combinations thereof.

In another embodiment of the method of the present invention, the business information report includes information selected from one or more of the group consisting of: a risk of late payment, a payment trends profile, a credit limit recommendation, a composite score of the business entity's financial strength and creditworthiness, and an overview of how the business entity has paid its bills.

In another embodiment of the method of the present invention, the business information report is delivered by an application selected from the group consisting of: Remote Windows Socket (RWS), Small Business Server (SBS), and e-mail.

In another embodiment of the method of the present invention, the user is alerted to the change via e-mail.

An embodiment of the computer system of the present invention includes a memory having stored therein business information data, a processing unit and computer-readable storage arranged to process and store programs and program components. The computer system also includes a program component, stored in the storage, that is arranged to perform the steps of automatically and periodically accessing business information on a business entity from one or more databases, updating business information data in the memory with the business information, updating at least one business information report on the business entity from the memory, and automatically alerting a user of a change in the business information report.

In another embodiment of the computer system of the present invention, the program component performs the further step of, upon request from the user, delivering the at least one business information report to the user.

In another embodiment of the computer system of the present invention, the database is at least one credit report.

In another embodiment of the computer system of the present invention, the business information report includes information selected from the group consisting of: credit information, payment history, key business ratios that measure financial strength, profitability, debts, assets, corporate relationships, and any combinations thereof.

In another embodiment of the computer system of the present invention, the business information report includes information selected from one or more of the group consisting of: a risk of late payment, a payment trends profile, a credit limit recommendation, a composite score of the business entity's financial strength and creditworthiness, and an overview of how the business entity has paid its bills.

In another embodiment of the computer system of the present invention, the business information report is delivered by an application selected from the group consisting of: Remote Windows Socket (RWS), Small Business Server (SBS), and e-mail.

In another embodiment of the computer system of the present invention, the user is alerted to the change via e-mail.

An embodiment of the computer-readable medium of the present invention has stored thereon executable instructions for performing steps including automatically and periodically accessing business information on a business entity from one or more databases, updating a business information database with the business information, updating at least one business information report on the business entity from the business information database, and automatically alerting a user of a change in the business information report.

In another embodiment of the computer-readable medium of the present invention, the instructions perform the further step of, upon request from the user, delivering the at least one business information report to the user.

In another embodiment of the computer-readable medium of the present invention, the database is at least one credit report.

In another embodiment of the computer-readable medium of the present invention, the business information report includes information selected from the group consisting of: credit information, payment history, key business ratios that measure financial strength, profitability, debts, assets, corporate relationships, and any combinations thereof.

In another embodiment of the computer-readable medium of the present invention, the business information report includes information selected from one or more of the group consisting of: a risk of late payment, a payment trends profile, a credit limit recommendation, a composite score of the business entity's financial strength and creditworthiness, and an overview of how the business entity has paid its bills.

In another embodiment of the computer-readable medium of the present invention, the business information report is delivered by an application selected from the group consisting of: Remote Windows Socket (RWS), Small Business Server (SBS), and e-mail.

In another embodiment of the computer-readable medium of the present invention, the user is alerted to the change via e-mail.

### BRIEF DESCRIPTION OF THE DRAWINGS

FIG. 1 is a chart depicting a Selfmonitor screenshot showing a product matrix which describes product value and features according to the present invention;

FIG. 2 is a screenshot showing a product detail page which provides detailed product description, pricing, links to a product example and case study and product purchase options;

FIG. 3 is a screenshot showing a case study according to the present invention;

FIG. 4 is a screenshot showing a banner with auto-refresh details and table of contents according to the present invention; and

FIG. 5 is a screenshot showing payment trend information, such as risk of late payment and payment performance trend which are rendered separately via pop-ups.

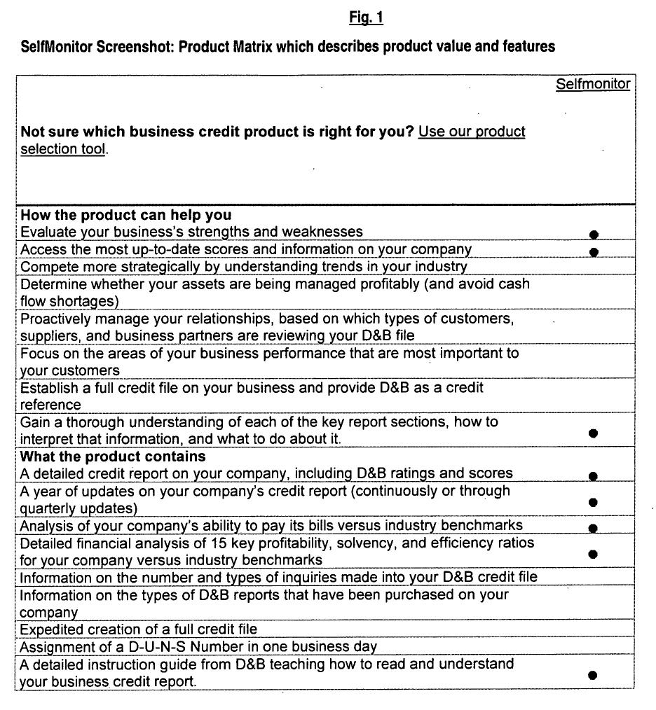

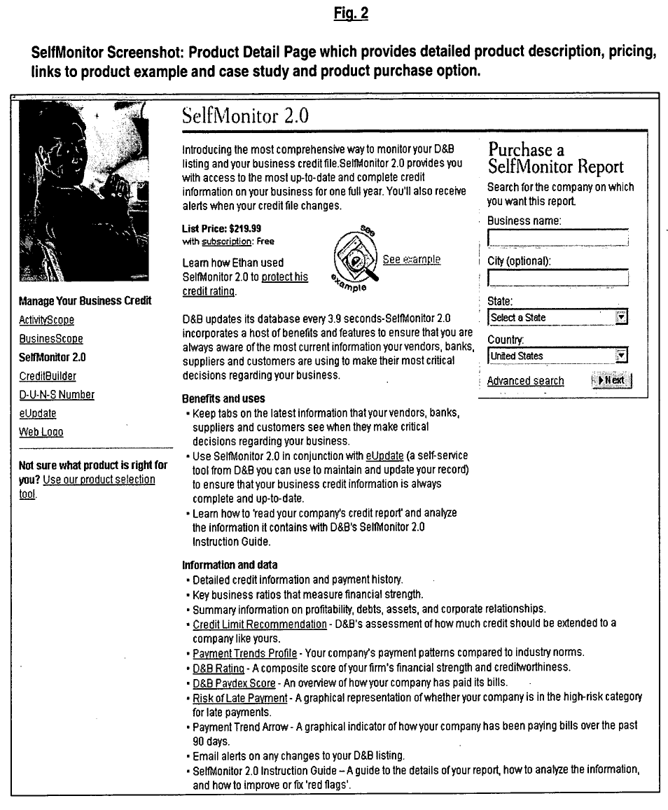

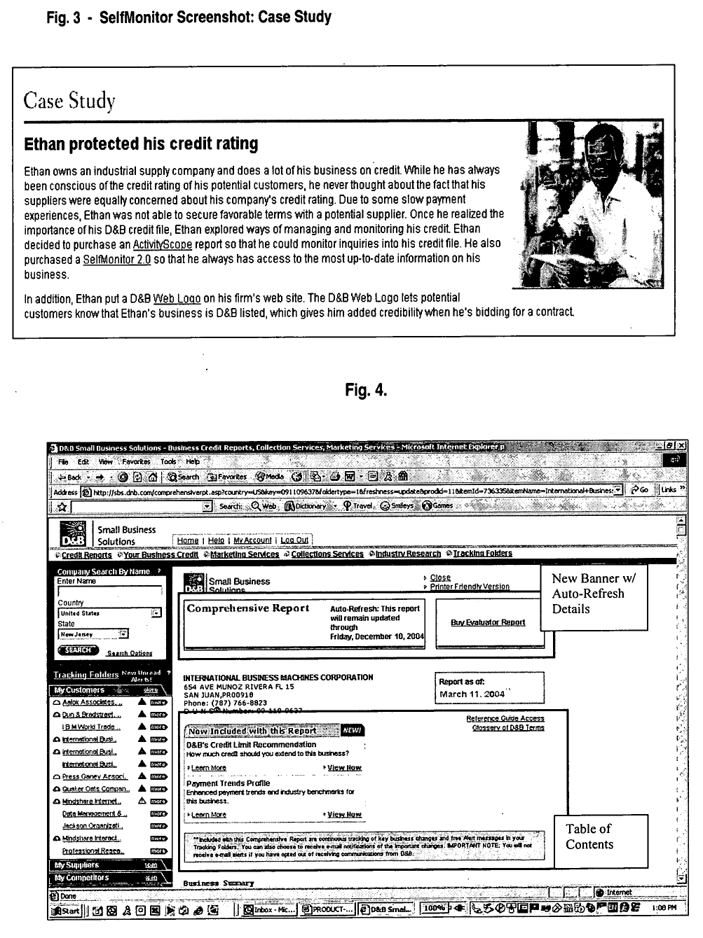

### DETAILED DESCRIPTION OF THE PREFERRED EMBODIMENT

The SelfMonitor according to the present invention is the most comprehensive way to monitor a company's business credit file and other credit information. It provides companies with access to the most up-to-date credit information on their business and provides an auto-alert when the company's credit file changes.

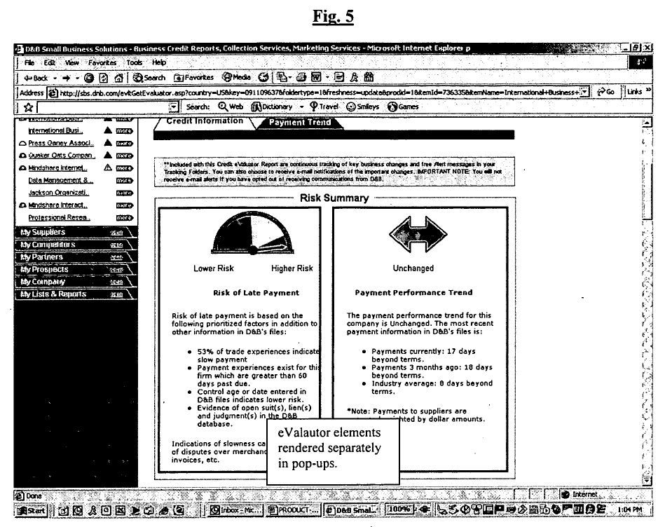

A “Table of Contents”, and example of which is shown in FIG. 4, highlights the features of SelfMonitor and provides the customer with a set of links to the following information:
Comprehensive Report: This is an anchor link that takes the user down into the overall report.
Risk of Late Payment Dial: Spawns a pop-up window containing the dial from the eValuator, as shown in FIG. 5.
Payment Trend Arrow: Spawns a pop-up window containing a payment trend arrow from the evaluator.
Payment Trend Profile: Spawns a pop-up window containing the payment trend profile (as it is currently implemented), as shown in FIG. 5.
Credit Limit Recommendation: Spawns a pop-up window containing the recommendation (as it is currently implemented).
SelfMonitor Instruction Guide: Spawns a PDF document that educates the customer on the features and benefits of SelfMonitor.
   eValuator Elements

To provide the customer with a more comprehensive perspective on the credit reports on their company, the “Risk of Late Payment Dial” and the “Payment Trend Arrow” will be made available from the SelfMonitor. A link will appear on SelfMonitor that will take the user out to these two elements similar to how the “Credit Limit Recommendation” and “Payment Trends Profile” are handled.

Segmentation

SelfMonitor will be delivered to the customer through Remote Windows Socket (“RWS”) or Small Business Server (“SBS”), depending on company size and/or customer relationship. For customers who order through SBS, the report will be delivered through SBS, and the same holds true for RWS. For customers who order through the Data & Operations (“D&O”) sales and service organization (over the phone), we need to enable the ability to register a customer on either site (based on customer choice or size of business) and deliver the product to the appropriate account.

Quarterly Email Push

D&O currently sends an email to its Monitoring Scope customers every quarter containing the most updated report on their company. This functionality will be replicated, but the email will provide a link for the customer to come back to the appropriate site within which the report is rendered to view their most updated information.

Credit agencies typically update their databases every 3.9 seconds—SelfMonitor ensures that a business entity is always aware of the information its vendors, banks, suppliers and customers are using to make decisions regarding the business entity.

Benefits and Uses

A user can keep tabs on the latest information that vendors, banks, suppliers and customers see when they make critical decisions regarding the user's business. The user can ensure that the business credit information of a business entity is always up-to-date and complete. The user can also use SelfMonitor in conjunction with an eUpdate process to ensure that business credit information is always up-to-date.

Information and Data

Detailed credit information and payment history.

Key business ratios that measure financial strength.

Summary information on profitability, debts, assets, and corporate relationships.

Credit Limit Recommendation—an assessment of how much credit should be extended to the company.

Payment Trends Profile—a company's payment patterns compared to industry norms.

Rating—a composite score of a firm's financial strength and creditworthiness.

Paydex Score—an overview of how a company has paid its bills.

Risk of Late Payment Dial—a graphical representation of whether a company is in the high-risk category for late payments.

Payment Trend Arrow—a graphical indicator of how a company has been paying bills over the past 90 days.

A SelfMonitor Instruction Guide to walk a user through the details of your report, how to analyze all of the information you see, and how to improve or fix ‘red flags’.

What is claimed is:

1. A method for monitoring business information, comprising the computer-implemented steps of:
automatically and periodically accessing business information on a business entity from one or more databases;
updating a business information database with said business information;
updating at least one business information report on said business entity from said business information database; and
automatically alerting a user of a change in said business information report.

2. The method of claim 1 , further comprising:
upon request from said user, delivering said at least one business information report to said user.

3. The method of claim 1, wherein said database is at least one credit report.

4. The method of claim 1, wherein said business information report includes information selected from the group consisting of: credit information, payment history, key business ratios that measure financial strength, profitability, debts, assets, corporate relationships, and any combinations thereof.

5. The method of claim 4, wherein said business information report includes information selected from one or more of the group consisting of: a risk of late payment, a payment trends profile, a credit limit recommendation, a composite score of said business entity's financial strength and creditworthiness, and an overview of how said business entity has paid its bills.

6. The method of claim 1, wherein said business information report is delivered by an application selected from the group consisting of: Remote Windows Socket (RWS), Small Business Server (SBS), and e-mail.

7. The method of claim 1, wherein said user is alerted to said change via e-mail.

8. A computer system for monitoring credit information, comprising:
a memory having stored therein business information data;
a processing unit and computer-readable storage arranged to process and store programs and program components; and
a program component, stored in the storage, that is arranged to perform the steps of:
automatically and periodically accessing business information on a business entity from one or more databases;
updating business information data in said memory with said business information;
updating at least one business information report on said business entity from said memory; and
automatically alerting a user of a change in said business information report.

9. The computer system of claim 8, wherein said program component performs the further step of:
upon request from said user, delivering said at least one business information report to said user.

10. The computer system of claim 8, wherein said database is at least one credit report.

11. The computer system of claim 8, wherein said business information report includes information selected from the group consisting of: credit information, payment history, key business ratios that measure financial strength, profitability, debts, assets, corporate relationships, and any combinations thereof.

12. The computer system of claim 11, wherein said business information report includes information selected from one or more of the group consisting of: a risk of late payment, a payment trends profile, a credit limit recommendation, a composite score of said business entity's financial strength and creditworthiness, and an overview of how said business entity has paid its bills.

13. The computer system of claim 8, wherein said business information report is delivered by an application selected from the group consisting of: Remote Windows Socket (RWS), Small Business Server (SBS), and e-mail.

14. The computer system of claim 8, wherein said user is alerted to said change via e-mail.

15. A computer-readable medium for monitoring business information, having stored thereon executable instructions for performing steps comprising:
automatically and periodically accessing business information on a business entity from one or more databases;
updating a business information database with said business information;
updating at least one business information report on said business entity from said business information database; and
automatically alerting a user of a change in said business information report.

16. The computer-readable medium of claim 15, wherein said instructions perform the further step of:
upon request from said user, delivering said at least one business information report to said user.

17. The computer-readable medium of claim 15, wherein said database is at least one credit report.

18. The computer-readable medium of claim 15, wherein said business information report includes information selected from the group consisting of: credit information, payment history, key business ratios that measure financial strength, profitability, debts, assets, corporate relationships, and any combinations thereof.

19. The computer-readable medium of claim 18, wherein said business information report includes information selected from one or more of the group consisting of: a risk of late payment, a payment trends profile, a credit limit recommendation, a composite score of said business entity's financial strength and creditworthiness, and an overview of how said business entity has paid its bills.

20. The computer-readable medium of claim 15, wherein said business information report is delivered by an application selected from the group consisting of: Remote Windows Socket (RWS), Small Business Server (SBS), and e-mail.

21. The computer-readable medium of claim 15, wherein said user is alerted to said change via e-mail.
